(19) United States
(12) Patent Application Publication
(10) Pub. No.: US 2020/0156042 A1
(43) Pub. Date: May 21, 2020

(54) EQUIPMENT FOR THE PRODUCTION OF BICARBONATES

(71) Applicant: Carlos Manuel MIRANDA MACAS NOGUEIRO, Ribeira De Nisa (PT)

(72) Inventor: Carlos Manuel MIRANDA MACAS NOGUEIRO, Ribeira De Nisa (PT)

(21) Appl. No.: 16/610,671

(22) PCT Filed: May 2, 2018
(86) PCT No.: PCT/IB2018/053040

§ 371 Date: Nov. 4, 2019

(30) Foreign Application Priority Data
May 3, 2017 (PT) 110051

(51) Int. Cl. B01J 19/18; C01B 32/60; B01J 4/00; B01J 19/00; B01J 4/02

(52) U.S. Cl. CPC B01J 19/18; C01B 32/60; B01J 4/007; B01J 2219/0027; B01J 4/02; B01J 2219/00092; B01J 2219/00247; B01J 19/0066

(57) ABSTRACT

An equipment for the production of bicarbonates is provided. It has a reactor tank, a safety valve, a manometer, an electric engine, a solute feeding pipe, a water inflow spigot, gas inflow spigot, a propeller, a sampling pipe with spigot, an outflow pipe, a support structure and cooling cladding located around the cylindrical part of the equipment. Also disclosed is an embodiment of the above-mentioned equipment having a solute hoisting system comprising a micronized carbonate powder stock, a conveyor belt for feeding the powder to the semi-automatic electric scale, an electric engine for the conveyor belt, a metal support structure, a conveyor belt for feeding the weighed powder to the reactor, an electric engine for the conveyor belt.

### TECHNICAL FIELD

This Application describes equipment for producing calcium bicarbonate and calcium and magnesium bicarbonates, as well as a solute hoisting system feeding such equipment.

### BACKGROUND

Currently, there is no safe and efficient way to produce calcium bicarbonates and calcium and magnesium bicarbonates either in a laboratory or industrially.

The natural transformation of carbonates into bicarbonates is extremely slow. An example of this phenomenon is the dissolution (corrosion) of limestone rock monuments, which are slowly corroded by water with a high carbon dioxide content.

In laboratory production of calcium bicarbonates and calcium and magnesium bicarbonates, the chemical reaction between the reagents is influenced by several factors, such as pressure built up in the equipment and the gas dissolved in the solution.

Carbonate solubility is affected by three factors: temperature, pressure and carbon dioxide.

For calcium carbonate solubility, i.e., the transformation of calcium carbonate into calcium bicarbonate, the chemical reaction that occurs is expressed through the following chemical equation:

Ca (CO₃)+H₂+CO₂⇔Ca⁺⁺+2 (HCO₃)⁻

For double calcium and magnesium carbonates (dolomite), the chemical reaction that occurs is expressed through the following chemical equation:

CaMg (CO₃)₂+2H₂+CO₂⇔Ca²⁺+Mg²⁻+4 (HCO₃)⁻

The chemical reactions of dissolving calcium carbonate into calcium bicarbonate and double calcium and magnesium carbonate into double calcium and magnesium bicarbonate in the presence of water are exothermic.

In order for the chemical reactions to proceed to the right, to obtain calcium bicarbonate or calcium and magnesium bicarbonates, cold must be applied to the chemical reactions.

Bicarbonate production is important since it has many beneficial qualities, for example, bicarbonates act quickly on plant root systems as, being in a liquid solution in the soil, they are ionic form and more easily absorbed by plants. Furthermore, they increase the pH of soil to 6 or 7, whereby nutrients present in the soil are more easily assimilated (through osmosis) by plant root systems.

Additionally, higher pH levels enhance microbiological activity in soils, such activity allowing better water penetration into the ground.

### SUMMARY

The present Patent Application refers to equipment for producing calcium bicarbonate or calcium and magnesium bicarbonate, characterized in that it comprises the following elements:
a reactor tank (11);
safety valve (17);
manometer (16);
electric engine (15);
solute feeding pipe (12) located on the opposite side of the upper part of the lid and comprising at least a spigot and a funnel-shaped loading nozzle (13);
water inflow spigot (18) located on the upper part of the side;
gas inflow spigot (22) located on the lower part of the equipment, as close as possible to the concave base of the equipment;
propeller (30) positioned between 8 and 12 centimeters from the bottom of the equipment;
a sampling pipe with spigot (20);
an outflow pipe (24) with a curve with an angle exceeding 90° and comprising a spigot (23);
support structure (29) for the hoisted reactor;
cooling cladding (19) located around the cylindrical part of the reactor.

In one embodiment, the equipment for the production of calcium bicarbonate or calcium and magnesium bicarbonate is fitted with a solute hoisting system that comprises:
a micronized carbonate powder stock (1);
a conveyor belt (2) for feeding the powder to the semi-automatic electric scale (6);
a semi-automatic scale (6);
an electric engine for the conveyor belt (4);
a metal support structure (8);
a conveyor belt for feeding the weighed powder to the reactor (9);
an electric engine for the conveyor belt (10);

In another embodiment, the loading nozzle (13) of the feeding pipe (12) comprises a protective mesh welded internally into the narrowest part of the funnel.

In one embodiment, the loading nozzle (13) has a diameter of 25 to 50 centimeters.

In one embodiment, the gas flow meter is fitted onto the gas inflow spigot (22).

In one embodiment, the water inflow spigot (18) comprises a water flow meter.

In another embodiment, the outflow pipe (24) has an internal diameter of 5 to 20 cm.

In one embodiment, the propeller (30) is coated with titanium or some other highly resistant corrosion-proof material.

In one embodiment, the support structure (29) is hoisted by 75 centimeters, although the structure may be hoisted to even higher levels.

### GENERAL DESCRIPTION

This technology is prompted by the need for safer and more efficient equipment for producing calcium bicarbonate and calcium and magnesium bicarbonates.

Thus, this technology aims to improve the equipment of the prior art for producing calcium bicarbonate and calcium and magnesium bicarbonate, obtaining better end-product characteristics and profitability.

Addressing several factors that influence the production of calcium bicarbonates and calcium and magnesium bicarbonates, the equipment of the prior art that is used to produce these bicarbonates has been improved solving several technical problems.

The main factors influencing the production of bicarbonates are: temperature, pressure, carbon dioxide, pH, gas dissolved in the reaction solution, amount of water introduced, fineness of the solute, stirring of the solution, among others.

The technology presented herein intends to optimize the above-mentioned factors and also bridge some gaps related to the equipment known from the prior art for the production of bicarbonates, such as: solute feeding pipes (12), electric engine installation (15), manometer position (16), safety valve position (17), water inflow spigot (18), gas inflow spigot (22), outflow pipe (24), propeller type and position (30), among other production equipment components.

Additionally, this technology also comprises a solute hoisting system that makes the process run more easily, with better user safety.

### BRIEF DESCRIPTION OF THE FIGURES

For an easier understanding of this technology, Figures are appended hereto showing preferred embodiments, although with no intention of limiting the technique disclosed herein.

FIG. 1 illustrates the equipment of the prior art used for the production of bicarbonates, in which the reference numbers represent:
11—Reactor tank
12—Solute feeding pipe
15—Electric engine
16—Manometer
17—Safety valve
18—Water inflow spigot
20—Sampling pipe with spigot
22—Gas inflow spigot
24—Outflow pipe
26—Gauge
27—Backflow pipe
28—Electric pump
29—Reactor support structure

FIG. 2 illustrates the embodiment of the equipment as disclosed herein, in which the reference numbers represent:
1—Micronized carbonate powder stock
2—Conveyor belt for feeding the powder to the semi-automatic electric scale
3—Dividing wall between the powder storage area and the rest of the equipment
4—Electric engine for the conveyor belt
5—Leak-proof hopper for receiving the micronized powder
6—Semi-automatic scale with indicator and regulator of the amount to be weighed
7—Hopper for receiving the weighed powder
8—Metal support structure
9—Conveyor belt for the weighed powder
10—Electric engine
11—Reactor Tank
12—Solute feeding pipe
13—Loading nozzle
14—Feed control spigot
15—Electric engine
16—Manometer
17—Safety valve
18—Water inflow spigot
19—Cooling cladding
20—Sampling pipe with spigot
21—Gas meter
22—Gas inflow spigot
23—Solution outflow pipe spigot
24—Outflow pipe
25—Ladder for the operator to control the feed control spigot

FIG. 3 illustrates the interior of the reactor, showing the position of the propeller (30), which, in turn, is connected to the electric engine (15).

### DESCRIPTION OF THE EMBODIMENTS

The present application describes equipment used to produce calcium bicarbonate and calcium and magnesium bicarbonates, solving several technical difficulties and problems.

The solubility of carbonate and calcium and magnesium carbonate is influenced by three factors, notably temperature, pressure and carbon dioxide.

Based on the chemical reaction of calcium carbonate dissolution:

Ca (CO₃)+H₂+CO₂⇔Ca⁻⁺+2 (HCO₃)⁻

and based on the chemical reaction of double calcium and magnesium carbonate dissolution:

CaMg (CO₃)₂+2H₂+2CO₂⇔Ca²⁺+Mg²⁺+4(HCO₃)³¹

the following must be taken into consideration:
the chemical reactions of dissolving calcium carbonate and double calcium and magnesium carbonate in the presence of water and carbon dioxide are exothermic;
for the chemical reactions to proceed to the right, to obtain calcium bicarbonates and calcium and magnesium bicarbonates, cold must be applied to the chemical reactions.

It is also important to bear in mind how the reaction proceeds with pressure and water. With 5 mol of reagents and obtaining 4 mol of the reaction product, the reaction will proceed to the right if the pressure rises in the equipment by adding carbon dioxide. The equipment described herein allows internal pressures to reach 11×10³ Pa (11 bar).

Through controlling the temperature, it is possible to achieve bicarbonate concentrations that are higher than those achieved through processes with no temperature control. In order to reach the ideal volume of carbon dioxide dissolved in the water, the temperature must be less than 6° C. Since the colder the water, the more carbon dioxide dissolves.

The presence of carbon dioxide dissolved in the column of the water storage tank is an important factor to take into consideration, as this lowers the pH, leaving the medium acid. The pH value must not reach 6.5.

With an acid pH, the stability of the crystalline structure of the calcium carbonates and calcium and magnesium carbonates weakens, making it easier for them to dissolve into calcium and magnesium ions.

Considering the many different factors affecting the production of calcium and magnesium carbonates, the equipment is wrapped in cooling cladding (19) that insulates it on the outside, thus allowing regulation of the internal temperature of the solution.

With this modification, the final outcomes can be modified completely, achieving far higher concentrations of bicarbonates and standardizing the process.

Bicarbonate production with no temperature control leads to uneven results, as the water temperature varies by season, as well as place and depth of collection, among other factors.

This technology intends to provide an equipment for the production of bicarbonates with modifications in the use of carbon dioxide during the production process.

There are several factors that influence the chemical reaction, specifically for ensuring that it proceeds to the right: the pressure that builds up in the equipment; and the gas dissolved in a solution, which lowers the pH level. The gas input process must thus also be addressed by modifications.

If cooling cladding (19) is used to lower the temperature, for gas inflow a gas flow meter (21) must be adapted on the spigot pipe (22) connecting the gas bottle to the equipment, in order for the operator to control it. Furthermore, the gas inflow spigot (22) runs under the lower part of the reactor tank (11), as close as possible to the concave base of the equipment.

By combining the factors of cold, pressure and gas dissolved in the solution, and chemically analyzing the samples being taken during the bicarbonate production process, it is possible to study the parameters in order to achieve the best outcomes.

To control the water volume, a water flow meter has been introduced, fitted to the water inflow spigot (18) in order to make sure the exact volume is used.

Referring to FIG. 1, the amount of water indicated by the gauge (26) consists of only half the capacity of the storage tank; therefore, if it goes beyond this level, it is not possible to know how many liters are left in the tank. Thus the gauge (26) was removed from the equipment of the present technology, together with the spigot on which it was mounted. The existence of the gauge (26) is also considered a technical disadvantage, as due to high pressures inside the reactor, the gauge (26) seals are subject to heavy wear and tear, often allowing contents to leak from the reactor.

On the other hand, also with regard to FIG. 1, the spigot that is joined to the gauge (26) and indicates the mean capacity of the storage tank to purge the air has also been removed from the equipment of the present technology, since once the mean level is exceeded, air is purged through the solute feeding pipe (12).

By using half the volume of water in the storage tank, the upper part would have to be filled with gas, resulting in heavy consumption of the material used in the reaction, and a higher cost.

With regard to the solute, another important factor to be taken into consideration is its fineness. The solute is administered at a fineness of 0-2 millimeters, which allows the solution to have a gas and water contact surface that is far smaller than that of the calcium carbonate and calcium and magnesium carbonate with micronized particles.

The finer the particles, i.e. micronized, the greater the gas and water contact area, and therefore, the better the outcome.

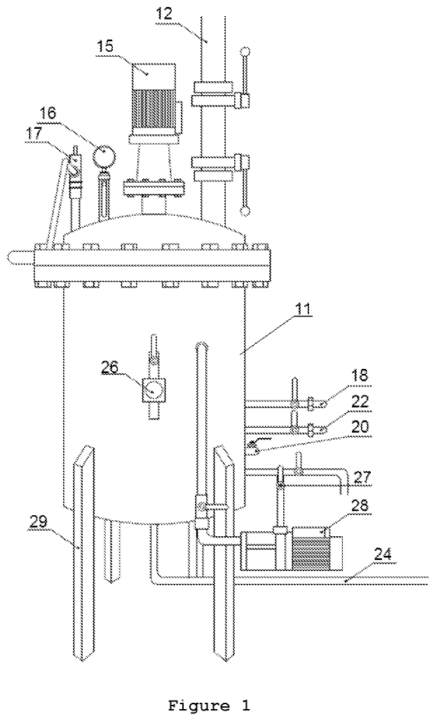

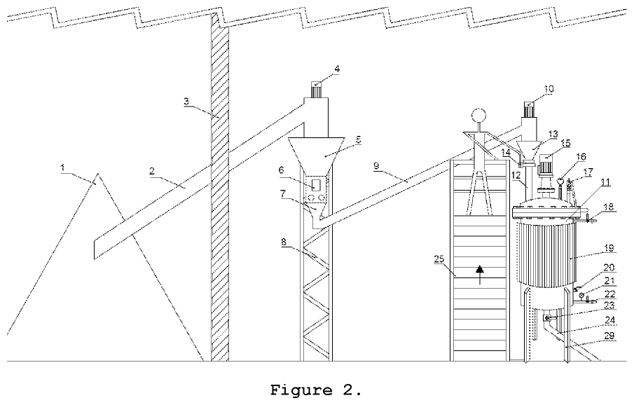

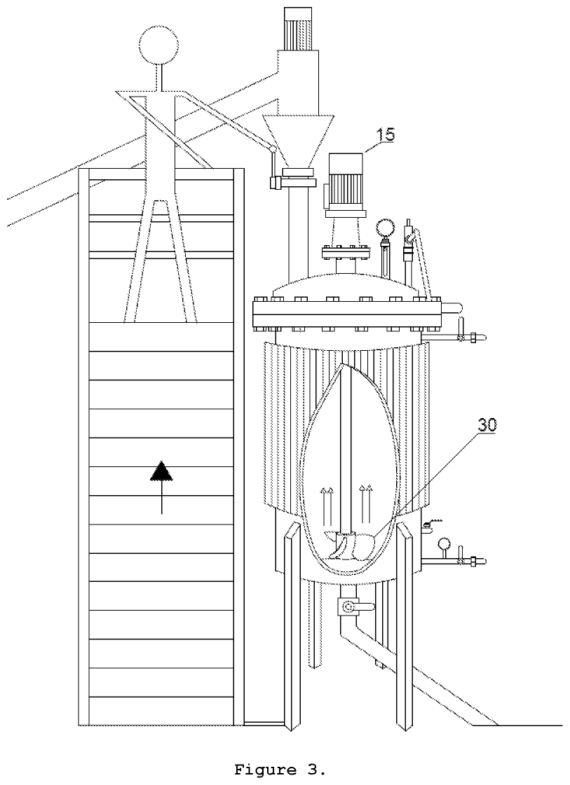

Another important aspect addressed by this technology is the stirring of the solution. The stirring of the solution is performed by the propeller (30) placed at the end of the axis that connects it to the electric engine (15), which is placed on the lid of the reactor tank (11) (FIG. 3).

In the equipment of the prior art, the propeller is located halfway up inside the equipment, causing the solution to move in a circular direction. With this process, the shape of the propeller and its placement halfway up, the material of which it is made and the type of stirring, the propeller sustains very heavy wear and tear in just a few months.

Thus, the propeller (30) should rather resemble a boat propeller, forcing the particles to move upwards through convection, so as to aspirate particles that tend to settle on the bottom of the tank during the process, forcing them into contact with the acid solution generated by the carbon dioxide. It must also be made from highly resistant corrosion-proof material or be coated with titanium, for significantly less wear and tear.

The propeller (30) as defined in this application is designed to drive a convection current that creates an upward movement of the solution and the particles, even with fewer rotations, thereby avoiding such heavy wear and tear of the blades of the propeller (30), while at the same time it ensures that the solute particles are always in contact with the water and gas, i.e. carbonic acid, for faster and easier modifications to their molecular structure, obtaining higher-concentration bicarbonates more quickly.

On the other hand, the percentage of silicon dioxide in the chemical composition of the carbonates is another important factor in improving bicarbonate production and equipment. The existence of silicon depends on the origin of the carbonate rock, as occurs with calcium carbonates and double calcium and magnesium carbonate dolomites. When analyzing the form of silicon dioxide, in general, a maximum figure of 8% of silicon dioxide is found in dolomites.

Thus, another modification introduced to the equipment disclosed herein consists of extending the axis of the engine (15) so that the propeller (30) is positioned at 8 to 12 centimeters from the bottom of the equipment and coated with a titanium-based coating, or some other highly resistant corrosion-proof material. This modification is very important as it keeps all the solute in constant movement through convection and in contact with the acid medium, thereby modifying the crystalline structure of the carbonates and obtaining high concentrations of bicarbonates, magnesium and calcium ions.

The following modification has also been made to the solute: the electric pump (28) connected to the reactor tank (11) has been removed, the purpose of which was to aspirate the particles forming in the vortex around the axis, as well as all the pipes (27) connected to the pump (28) have also been removed.

This modification is undertaken due to the fact that it is possible to modify the shape of the propeller (30) and its position, 8 to 12 centimeters above the bottom of the equipment and inside the equipment. In the equipment of the prior art, this propeller caused a rotational movement in the solution, but with the new propeller (30) format of the present technology, a convection movement is triggered, i.e., upward movement of the entire solution being processed, and downward movement of all parts that brush against the walls of the equipment.

Particles measuring 2 millimeters or more that were formerly aspirate no longer exist, with advantages not only in terms of the wear and tear to the propeller, but also in terms of the contact surface of the components of the solution, which is far smaller than in the case of micronized particles.

When the solute is fed into the equipment, given the height it is at, a stepladder is normally used. This procedure provides no safety at all for the operator, not only is the position uncomfortable and unsafe, but there is also no place to put down the bag containing the solute which weighs at least 30 kilograms. The equipment proposed in this patent application will have a capacity for solid solute of up to 150 kilograms and a maximum liquid capacity of 1000 liters.

Therefore, in order to improve this aspect, making the procedure more comfortable and avoiding accidents, it is necessary to add a solute hoisting system to the equipment, from the base where the equipment is installed up to the loading nozzle (13) of the feeding pipe (12), wherein the loading nozzle (13) will have a diameter of 25 to 50 centimeters, allowing the solute to be offloaded by the conveyor belt, thus avoiding powder dropping onto the reactor. The conveyor belt is attached to a scale, allowing for very accurate solute values to be obtained.

There are usually two spigots on the feeding pipe (12), although only one of them is necessary. Two spigots were placed on the equipment in case it was necessary to add more solute. Accordingly, during the production process, the upper spigot would be open and the solute would be added, while the lower spigot would be closed. The upper spigot would then be closed and the lower spigot would be opened, with the solute flowing into the solution being processed. Due to the amount of solute to be added and the new feeding system, one of the spigots is no longer necessary, leaving only the spigot (14) that allows the control of the inflow of solute into the reactor tank (11). In turn, the protective mesh will be placed inside the feeding pipe (12) and welded into it, the function of which is to prevent any objects from falling into the storage tank, thus avoiding the need to dismantle the entire equipment in order to remove an object that fell into the tank.

The electrical installation of the engine (15) and the position of the manometer (16) and safety valve (17) are modified during assembly, so as to place the feeding pipe (12) on the opposite side of the upper part of the lid, with this position of the solute feeding pipe (12) making the operation easier, as there are fewer pipes underneath.

Currently, in the equipment of the prior art the internal diameter of the outflow pipe (24) is extremely small, resulting in constant clogging that is rather hard to solve. Raising the structure (29) by 75 cm and increasing the pipe diameter will facilitate the placement of a spigot. Furthermore, the curve of the outflow pipe (24) may be much less pronounced, thus avoiding 90° angles.

Moreover, the outflow pipe (24) must have a larger internal diameter, between 5 and 20 centimeters, and extend vertically for about 30 centimeters in order for a spigot to be fitted, and then curve at an angle of more than 90°. This modification is intended to make the end product flow out more easily. It should also be stressed that, having modified the propeller (30) and the movement of the solution, movement through convection, the solute no longer precipitates easily, as occurs with equipment of the prior art. By opening the spigot (23) on the outflow pipe (24), the solution runs more easily through the pipe which leads to the decantation system, as it is drawn by the movement of the propeller (30).

It should also be noted that, when offloading, the rotation of the propeller (30) decreases for an easier outflow of the bicarbonates.

It is also apparent that inside cleaning of the equipment of the prior art is poor. In order to improve this aspect and ensure efficient cleaning, the position of the water inflow has been modified on the equipment. As a result, the water inflow spigot (18) is now located on the upper part of the side of the equipment and the water pipe extends internally as far as the axis of the electric engine (15). A pierced sphere has been placed at the end of the water pipe, covering its entire surface, to spray the water in every direction inside of the equipment, thereby washing it. The water runs down the walls and over the entire concave base at the bottom of the equipment, rinsing away left-over solute, which used to be a very difficult task, frequently clogging up the outflow pipe (24).

### Embodiments

This technology thus proposes modifications to the equipment commonly used to produce calcium bicarbonate and calcium and magnesium bicarbonates, improving it and solving several technical difficulties and problems.

In one embodiment, the present patent application addresses an piece of equipment for the production of bicarbonates which comprises:
a reactor tank (11);
a safety valve (17);
a manometer (16);
an electric engine (15);
a solute feeding pipe (12) with a funnel-type loading nozzle (13);
a boat propeller-type propeller (30);
a water inflow spigot (18);
a gas inflow spigot (22);
a sampling pipe with spigot (20);
the outflow pipe (24) with the pipe curving at more than 90°;
cooling cladding (19) placed around the cylindrical part of the reactor;
hoisted reactor support structure (29).

In one embodiment, the diameter of the loading nozzle (13) is larger than that of the funnel, from 25 to 50 cm.

In one embodiment, the loading nozzle (13) will also have a mesh welded inside at the narrowest part of the funnel, in order to prevent objects from falling into the equipment.

In one embodiment, the propeller (30) is positioned 8 to 12 centimeters from the bottom of the equipment, with a titanium-based coating.

In one embodiment, the support structure (29) is hoisted by 75 centimeters; however, the structure may be hoisted even higher.

In an additional embodiment, the equipment also comprises a solute hoisting system that comprises:
a micronized carbonate powder stock (1);
a conveyor belt (2) for feeding the powder to the semi-automatic electric scale (6);
a semi-automatic scale (6);
an electric engine for the conveyor belt (4);
a metal support structure (8);
a conveyor belt for feeding the weighed powder to the reactor (9);
an electric engine for the conveyor belt (10).

Through the solute hoisting system, the solute is hoisted from the carbonates stock (1) through the conveyor belt up to the hopper (5), where it will be weighed on the semi-automatic scale (6), carried to the weighed powder hopper (7), then moving on to the conveyor belt (9) that will hoist the solute to the loading nozzle (13), where the weighed/dosed solute is then offloaded and fed into the reactor.

These are the modifications proposed by the present technology that are necessary and crucial for improving the overall functioning of the process and equipment for obtaining bicarbonates.

It must also be stressed that these modifications provide excellent space for installing the cooling cladding (19) around the cylindrical part of the equipment, as it is completely free of pipes or spigots.

The finished product leaves the equipment described above through an outflow pipe (24). An electric pump is attached to the outflow pipe (24) of the solution, for the solution to be kept in the storage tank for decantation. This storage tank, in turn, has an air release valve as it fills up. Once the storage tank is full, the solution is decanted and pumped into storage tanks with a capacity of 25 liters or more. During this operation, the liquid is also filtered in order to separate the micronized particles. When the liquid is being emptied from the decantation tank, care must be taken to avoid any stirring.

The storage tanks are fixed to the ground by mountings for ease and safety of the operation. These will have funnel-shaped bases with an outlet pipe having a diameter of 7.5 cm, fitted with a spigot, in order to simplify the outflow of the decanted material and washing.

Naturally, the present description is not in any way limited to the embodiments presented herein, and a person of ordinary skill in the art will envisage many possibilities for modifying it without departing from the general idea as defined in the claims. The preferred embodiments described above are obviously interchangeable among themselves. The following claims define additional preferred embodiments.

1. An equipment for the production of calcium bicarbonate or calcium and magnesium bicarbonate comprising the following elements:
a reactor tank;
a safety valve;
a manometer;
an electric engine;
a solute feeding pipe located on the an opposite side of an the upper part of the a lid and comprising at least a spigot and a funnel-shaped loading nozzle;
a water inflow spigot located on the upper part of the side;
a gas inflow spigot located on a the lower part of the equipment, as close as possible to a the concave base of the equipment;
a propeller positioned between 8 and 12 centimeters from a the bottom of the equipment;
a sampling pipe with spigot;
an outflow pipe with a curve with an angle exceeding 90° and comprising a spigot;
a support structure for the hoisted reactor;
cooling cladding placed around the a cylindrical part of the reactor.

2. The equipment for the production of calcium bicarbonate or calcium and magnesium bicarbonate according to claim 1, wherein the pressure in the reactor rises to 11×10⁵ Pa (11 bar).

3. The equipment for the production of calcium bicarbonate or calcium and magnesium bicarbonate according to claim 1, wherein the temperature in the reactor is kept below 6° C.

4. The equipment for the production of calcium bicarbonate or calcium and magnesium bicarbonate according to claim 1, wherein the propeller provides stirring by convection in the reactor.

5. The equipment for the production of calcium bicarbonate or calcium and magnesium bicarbonate, according to claim 1, wherein the lifting of the solute is carried out by a solute hoisting system comprises:
a micronized carbonate powder stock;
a conveyor belt for feeding the powder to the semi-automatic electric scale;
a semi-automatic scale;
an electric engine for the conveyor belt;
a metal support structure;
a conveyor belt for feeding the weighed powder to the reactor; and
an electric engine for the conveyor belt.

6. The equipment for the production of calcium bicarbonate or calcium and magnesium bicarbonate according to claim 1, wherein the loading nozzle of the feeding pipe comprises a protective mesh welded inside at the narrowest part of the funnel.

7. The equipment for the production of calcium bicarbonate or calcium and magnesium bicarbonate according to claim 1, wherein the loading nozzle has a diameter of 25 to 50 cm.

8. The equipment for the production of calcium bicarbonate or calcium and magnesium bicarbonate according to claim 1, wherein the gas inflow spigot comprises a gas flow meter.

9. The equipment for the production of calcium bicarbonate or calcium and magnesium bicarbonate according to claim 1, wherein the water inflow spigot comprises a water flow meter.

10. The equipment for the production of calcium bicarbonate or calcium and magnesium bicarbonate according to claim 1, wherein the outflow pipe has an internal diameter of 5 to 20 cm.

11. The equipment for the production of calcium bicarbonate or calcium and magnesium bicarbonate according to claim 1, wherein the propeller is coated with highly resistant corrosion-proof material.

12. The equipment for the production of calcium bicarbonate or calcium and magnesium bicarbonate according to claim 1, wherein the highly resistant corrosion-proof material is titanium.
